(19) United States
(12) Patent Application Publication
(10) Pub. No.: US 2003/0121378 A1
(43) Pub. Date: Jul. 3, 2003

(54) Diodometer

(76) Inventor: Robert D. Sirois, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/683,433

(22) Filed: Dec. 28, 2001

(51) Int. Cl. B26D 7/27

(52) U.S. Cl. 83/13; 83/50; 83/522.29; 83/613; 83/684

(57) ABSTRACT

A method for manufacturing includes a machine capable of operating with and without a stock material present and an apparatus responsive to each operation when the stock material is present and unresponsive when the stock material is absent.

### BACKGROUND OF INVENTION

This invention relates generally to counting in stamp press operations and, more particularly, to accurately counting the number of actual strokes accumulated on stamping dies.

Generally accumulated number of strokes on a stamping die are collected by manually or automatically recording the number of total strokes achieved during each die run. The counted total of number of strokes includes actual strokes and false strokes. Actual strokes are defined as strokes performed by a stamping die with material stock present. False strokes are defined as strokes performed by a stamping die without material stock present. However, false strokes have little or no effect on the life of a stamping die.

### SUMMARY OF INVENTION

In one aspect of the invention, a method for manufacturing includes a machine capable of operating with and without a stock material present and an apparatus responsive to each operation when the stock material is present and unresponsive when the stock material is absent.

In another aspect of the invention, an apparatus for determining a number of operations by a machine on a stock material is provided. The apparatus includes a strain gage configured to signal the operation of the machine and an optical sensor configured to verify the presence of stock material. The apparatus also includes an accumulator operably coupled to the strain gage and the optical sensor.

In another aspect of the invention, a punch press system for manufacturing articles is provided. The system includes a cooperating punch section and die section for creating the articles from a stock material moving therethrough. The system also includes an apparatus for determining a number of operations by a machine on a stock material secured in at least one of the punch and the die section.

### BRIEF DESCRIPTION OF DRAWINGS

FIG. 1 is a cross-sectional view of an apparatus for determining a number of operations by a machine on a stock material.

FIG. 2 is a cross-sectional view of a punch press system including the apparatus shown in FIG. 1.

FIG. 3 is a cross-sectional view of a punch press system including the apparatus shown in FIG. 1.

### DETAILED DESCRIPTION

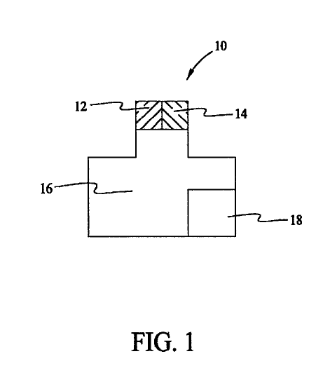

FIG. 1 is a cross-sectional view of an apparatus 10 for determining a number of operations by a machine (not shown) on a stock material (not shown in FIG. 1) i.e., number of actual strokes. Apparatus 10 includes a strain gage 12, an optical sensor 14, an accumulator 16, and a display 18. In an exemplary embodiment, strain gage 12, optical sensor 14, accumulator 16, and display 18 are disposed substantially adjacent each other such that removal of at least one of strain gage 12, optical sensor 14, accumulator 16, and display 18 will at least partially destroy apparatus 10. In another embodiment, accumulator 16 and display 18 are disposed substantially distant, and strain gage 12 and optical sensor 14 are disposed substantially adjacent such that removal of at least one of strain gage 12 and optical sensor 14 will at least partially destroy apparatus 10.

In one embodiment, strain gage 12 is at least one of a wire strain gage and a foil strain gage configured to transmit a signal when the machine operates. Alternatively, any commercially available strain gage may be used which transmits a signal when a load on the strain gage surpasses a predetermined amount.

In one embodiment, optical sensor 14 is at least one of a photo cell and a diode in conjunction with at least one of a lamp, a light-emitting diode, and a laser configured to transmit a signal when the stock material is present. Alternatively, any commercially available optical sensor may be used which transmits a signal when the presence of a material is detected.

Accumulator 16 is configured to determine a number of operations based on receiving at least one signal from strain gage 12 and optical sensor 14. Accumulator 16 is also configured to transmit a signal to display 18. To determine a number of operations, accumulator 16 is configured to transmit a signal after receiving both a signal from strain gage 12 and a signal from optical sensor 14.

In one embodiment, display 18 is at least one of a mechanical display, a dial-type display, and an electric display configured to receive a signal from accumulator 16.

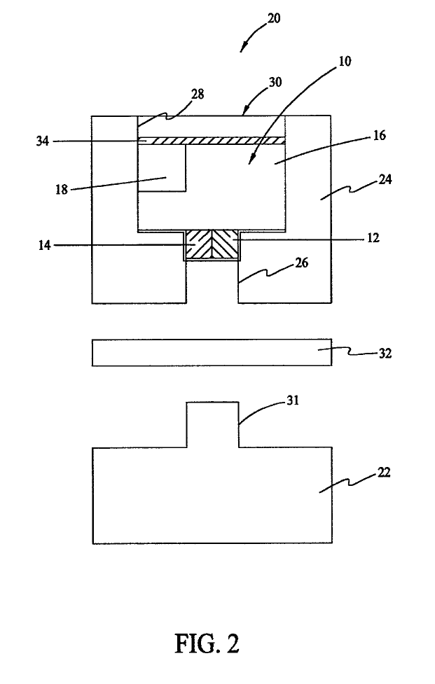

FIG. 2 is a cross-sectional view of a punch press system 20 including apparatus 10 (shown in FIG. 1). Punch press system 20 includes a cooperating punch 22 and die 24 section. Die section 24 includes a die shoe 26 including a receptacle 28 and a cavity 30 therein. Punch section includes a punch 31. Punch press system 20 also includes a stock material 32 moving therethrough.

In an exemplary embodiment, apparatus 10 is encapsulated in cavity 30 within receptacle 28 with a sealing material 34. In one embodiment, sealing material 34 is manufactured from a resinous material, such as, for example, but not limited to, an epoxy. In another embodiment, apparatus 10 is secured in cavity 30 within receptacle 28 with at least one of a fastener, a weld, and a sealing material such that attempted removal of apparatus 10 will at least partially destroy apparatus 10.

In operation, apparatus 10 installs into die section 24 inside cavity 30 within receptacle 28 adjacent to die shoe 26 to count actual strokes accumulated during press operations. Stock material 32 is fed through press section 22 and die section 24 so that holes are punched and/or a structural change is formed in stock material 32 when punch 31 moves through stock material 32 into die shoe 26. Optical sensor 14 detects the presence of stock material 32 and sends a signal to accumulator 16. Strain gage 12 detects a load and sends a signal to accumulator 16. Accumulator 16, only after receiving both signals from optical sensor 14 and strain gage 12, transmits a signal to display 18 and an actual stroke is counted. Accumulator 16 is not configured to transmit a signal unless both a signal from optical sensor 14 and a signal from strain gage 12 are present.

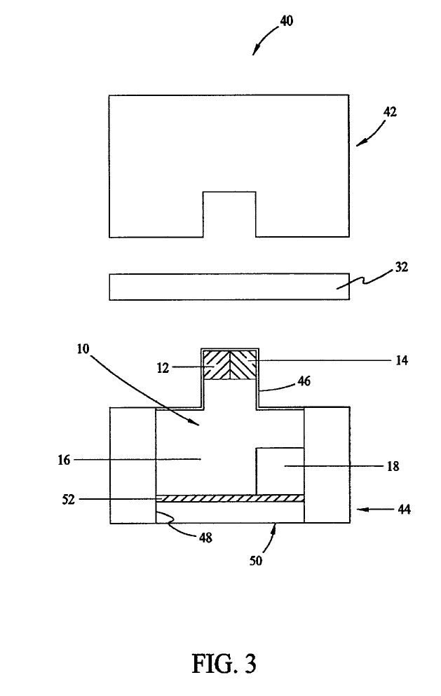

FIG. 3 is a cross-sectional view of a punch press system 40 including apparatus 10 shown in FIG. 1. Punch press system 40 includes a cooperating die section 42 and punch section 44. Punch section 44 includes a punch 46 including a receptacle 48 and a cavity 50 therein. Punch press system 40 further includes stock material 32 moving therethrough.

In an exemplary embodiment, apparatus 10 is encapsulated in cavity 50 within receptacle 48 with a sealing material 52. In one embodiment sealing material 52 is manufactured from a resinous material such as epoxy. In another embodiment, apparatus 10 is secured in cavity 50 within receptacle 48 with at least one of a fastener, a weld, and a sealing material such that attempted removal of apparatus 10 will at least partially destroy apparatus 10.

In operation, apparatus 10 installs into punch section 44 inside cavity 50 within receptacle 48 adjacent to punch 46 to count actual strokes accumulated during press operations. Stock material 32 is fed through punch section 44 and die section 42 so that holes are punched and/or a structural change is formed in stock material 32 when punch 46 moves through stock material 32 into die section 42. Optical sensor 14 detects the presence of stock material 32 and sends a signal to accumulator 16. Strain gage 12 detects a load and sends a signal to accumulator 16. Accumulator 16, only after receiving both signals from optical sensor 14 and strain gage 12, transmits a signal to display 18 and an actual stroke is counted. Accumulator 16 is not configured to transmit a signal unless both a signal from optical sensor 14 and a signal from strain gage 12 are present.

Daily maintenance or timing operations may require press systems 20 and 40 to operate without stock material 32 present. Apparatus 10 prevents these operations inadvertently counting towards the wear life of a stamping die. Running press systems 20 and 40 without stock material present, results in no signals transmitted from optical sensor or strain gage.

The above-described apparatus for counting actual strokes accumulated on stamping dies is reliable, accurate, and tamper resistant. The apparatus integrates and cooperates easily into a variety of punch press systems. As such, a cost-effective and accurate apparatus is provided.

While the invention has been described in terms of various specific embodiments, those skilled in the art will recognize that the invention can be practiced with modification within the spirit and scope of the claims.

1. A method for manufacturing, said method comprising:
providing a machine capable of operating with and without a stock material present; and
providing an apparatus responsive to each operation when the stock material is present and unresponsive when the stock material is absent.

2. A method in accordance with claim 1 wherein providing a machine comprises providing a machine capable of operating with structural change to the stock material.

3. A method in accordance with claim 1 wherein providing an apparatus comprises positioning an apparatus in the machine.

4. A method in accordance with claim 1 wherein providing an apparatus comprises providing an apparatus including a strain gage responsive to each operation of the machine.

5. A method in accordance with claim 1 wherein providing an apparatus comprises providing an apparatus including a strain gage configured to signal when a load surpasses a predetermined amount resulting when the machine operates.

6. A method in accordance with claim 1 wherein providing an apparatus comprises providing an apparatus including an optical sensor responsive when the stock material is present.

7. A method in accordance with claim 1 wherein providing an apparatus comprises providing an apparatus including an optical sensor configured to signal the presence of stock material.

8. A method in accordance with claim 1 wherein said providing an apparatus comprises providing an apparatus including a means for receiving and displaying a signal from at least one of a strain gage and an optical sensor.

9. An apparatus for determining a number of operations by a machine on a stock material, said apparatus comprising:
a strain gage configured to signal the operation of the machine;
an optical sensor configured to verify the presence of stock material; and
an accumulator operably coupled to said strain gage and said optical sensor, said accumulator configured to receive a signal transmitted from said strain gage and said optical sensor.

10. An apparatus in accordance with claim 9 wherein said strain gage, said optical sensor, and said accumulator disposed substantially adjacent each other such that removal of at least one of said strain gage, said optical sensor, and said accumulator will at least partially destroy said apparatus.

11. An apparatus in accordance with claim 9 wherein said accumulator disposed substantially distant, and said strain gage and said optical sensor disposed substantially adjacent each other such that removal of at least one of said strain gage and said optical sensor will at least partially destroy said apparatus.

12. An accumulator in accordance with claim 9 wherein said accumulator comprises a display connected to receive a signal from said accumulator.

13. An apparatus in accordance with claim 9 wherein said strain gage comprises at least one of a wire strain gage and a foil strain gage.

14. An apparatus in accordance with claim 9 wherein said optical sensor comprises:
a photocell and a diode; and
at least one of a lamp, a light-emitting diode, and a laser.

15. An apparatus in accordance with claim 17 wherein said apparatus configured to determine a number of actual strokes based on at least one signal from the strain gage and the optical sensor.

16. A punch press system for manufacturing articles, said punch press system comprising:
a cooperating punch section and die section for creating said articles from a stock material moving therethrough;
an apparatus for determining a number of operations by said punch press system on the stock material, said apparatus secured in at least one of said punch section and said die section.

17. A system in accordance with claim 16, wherein said apparatus comprises:
a strain gage; and
an optical sensor, said strain gage and optical sensor output an electric signal when said press operates and the material stock is present.

18. A system in accordance with claim 16, wherein said system comprises at least one receptacle having at least one sensor disposed therein, said receptacle disposed at least partially within cavity in said punch section or die section.

19. A system in accordance with claim 16, wherein said system comprises: a receptacle disposed within a cavity in said die section; and a sealing material, said apparatus disposed within said cavity, said sealing material covering said apparatus.

20. A system in accordance with claim 19, wherein said sealing material comprises an epoxy and substantially completely covers said apparatus, whereby removal of said epoxy will at least partially destroy said apparatus.
